(19) United States
(12) Patent Application Publication
(10) Pub. No.: US 2016/0148018 A1
(43) Pub. Date: May 26, 2016

(54) INFORMATION PROVIDING DEVICE, INFORMATION PROVIDING METHOD, AND PROGRAM

(71) Applicant: RAKUTEN, INC., Setagaya-ku, Tokyo (JP)

(72) Inventor: Kenji SUGIURA, Tokyo (JP)

(73) Assignee: Rakuten, Inc., Tokyo (JP)

(21) Appl. No.: 14/899,847

(22) PCT Filed: Jun. 21, 2013
(86) PCT No.: PCT/JP2013/067144

§ 371 Date: Dec. 18, 2015

(51) Int. Cl. G06F 21/62; H04L 12/58; G06F 17/30

(52) U.S. Cl. CPC G06F 21/6263; G06F 17/30604; H04L 51/32

(57) ABSTRACT

An information providing server (1) obtains a message from a poster, converts the posted message such that the amount of information thereof is reduced, based on the level of the amount of information to be transmitted to a viewer, the level being determined depending on the relationship between the poster and the viewer, to thereby generate a converted message, and sends the generated converted message to a user terminal of the viewer.

### TECHNICAL FIELD

The present invention relates to an information providing device, an information providing method, and a program.

### BACKGROUND ART

There has been available an information sharing system in which a user can view a message posted by another user. Such an information sharing system may control such that a target user or group to whom a message posted by a user is disclosed is set so that the message can be prevented from being viewed by other users or groups (see Patent Literature 1, for example).

### CITATION LIST

### Patent Literature

### Patent Literature 1: Japanese Patent Laid-open Publication No. 2008-146246

### SUMMARY OF INVENTION

### Technical Problem

However, although closeness in relationship between a poster and a viewer of a message may vary, such as a close friend, an acquaintance, or a stranger, according to the conventional technique, information posted is disclosed intact to any user allowed to view irrespective of the relationship with the poster as it is only controlled whether or not a message posted by a user is disclosed to other users. Accordingly, according to the conventional technique, a situation may be resulted in which even information which the poster does not wish to disclose, depending on the relationship with each viewer, is disclosed. Although it has been considered according to the conventional technique as well that a range of disclosure of information to a viewer is set by the poster with respect to each viewer, this is troublesome for the poster, and not practicable in view of the fact that viewers may not be specified at the time of posting a message.

The present invention has been conceived in view of the above described situation, and an object thereof is to provide an information providing device, an information providing method, and a program capable of reducing the amount of information posted by a poster to an amount in accordance with the relationship with the poster of the information and a viewer before providing to the viewer.

### Solution to Problem

In order to achieve the above described object, an information providing device according to the present invention includes an obtaining unit for obtaining posted information from a poster; a conversion unit for converting the posted information such that an amount of information of the posted information is reduced, based on the level of the amount of information to be transmitted to a viewer, the level being determined depending on the relationship between the poster and the viewer; and a providing unit for providing the posted information converted to the viewer.

In one aspect of the present invention, the information providing device may further include an extracting unit for extracting one or more data elements to be a conversion target from the posted information, and the conversion unit may reduce the amount of information of each of the data elements extracted by the extracting unit, based on the level of the amount of information determined depending on the relationship between the poster and the viewer.

In one aspect of the present invention, the information providing device may further include a storage unit for storing conversion rule information that defines a conversion rule for conversion into a plurality of conversion candidates that are different in the level of the amount of information for every kind of data, and the conversion unit may convert each of the data elements extracted by the extracting unit, based on conversion rule information stored in the storage unit with respect to the kind of that data element and the level of the amount of information determined depending on the relationship between the poster and the viewer.

In one aspect of the present invention, the information providing device may further include an evaluation value obtaining unit for obtaining an evaluation value indicating closeness in relationship between the poster and each of one or more viewers, and the conversion unit may convert such that the amount of information of the posted information converted with respect to a first viewer is smaller than the amount of information of the posted information converted with respect to a second viewer when it is determined, based on the evaluation value obtained by the evaluation value obtaining unit, that the relationship between the poster and the first viewer is less close than the relationship between the poster and the second viewer.

In one aspect of the present invention, the conversion unit may convert such that the amount of information of a data element obtained by converting a data element extracted to be a conversion target from the posted information with respect to the first viewer is smaller than the amount of information of a data element obtained by converting a data element as the conversion target with respect to the second viewer when it is determined, based on the evaluation value obtained by the evaluation value obtaining unit, that the relationship between the poster and the first viewer is less close than the relationship between the poster and the second viewer.

In one aspect of the present invention, the conversion unit may extract a larger number of data elements to be a conversion target from the posted information with respect to the first viewer than the number of data elements extracted to be the conversion target from the posted information with respect to the first viewer when it is determined, based on the evaluation value obtained by the evaluation value obtaining unit, that the relationship between the poster and the first viewer is less close than the relationship between the poster and the second viewer.

In one aspect of the present invention, when the data element extracted by the extracting unit is a proper noun, the conversion unit may mask or delete the number of letters in a character string included in the data element, the number being determined based on the level of the amount of information determined depending on the relationship between the poster and the viewer, to thereby convert the data element.

In one aspect of the present invention, when the data element extracted by the extracting unit is address data, the conversion unit may delete an address composing segment determined based on the level of the amount of information determined depending on the relationship between the poster and the viewer in an address composing segment included in the data element or replaces the address composing segment included in the data element by a superior address composing segment corresponding to the level of the amount of information determined depending on the relationship between the poster and the viewer, to thereby convert the data.

In one aspect of the present invention, when replacement data for replacement depending on the level of the amount of information is defined with respect to the data element extracted by the extracting unit, the conversion unit may replace the data element by replacement data corresponding to the level of the amount of information determined depending on the relationship between the poster and the viewer.

In one aspect of the present invention, when the data element extracted by the extracting unit is a motion picture data, the conversion unit may convert the motion picture data into a static image included in the motion picture data or attribute information of the motion picture data, depending on the level of the amount of information determined depending on the relationship between the poster and the viewer.

In one aspect of the present invention, the extracting unit may extract one or more data elements to be a conversion target from among the data elements included in the posted information, depending on priority levels set to respective data elements included in the posted information.

In one aspect of the present invention, the information providing device may further include an evaluation value obtaining unit for obtaining an evaluation value indicating closeness in relationship between the poster and the viewer; and a setting unit for setting a lower priority level to data on a user commonly included in a list of users linked to the poster and a list of users linked to the viewer in selection of a conversion target than a predetermined priority level when the evaluation value obtained by the evaluation value obtaining unit with respect to the poster and the viewer is equal to or greater than a threshold or greater than the threshold.

In one aspect of the present invention, the information providing device may further include an evaluation value obtaining unit for obtaining an evaluation value indicating closeness in relationship between the poster and the viewer; and a setting unit for setting a higher priority level to data on a user commonly included in a list of users linked to the poster and a list of users linked to the viewer in selection of a conversion target than a predetermined priority level when the evaluation value obtained by the evaluation value obtaining unit with respect to the poster and the viewer is equal to or greater than a threshold or greater than the threshold.

An information providing method according to the present invention includes an obtaining step of obtaining posted information from a poster; a conversion step of converting the posted information such that the amount of information of the posted information is reduced, based on the level of the amount of information to be transmitted to a viewer, the level being determined depending on the relationship between the poster and the viewer; and a providing step of providing the posted information converted to the viewer.

A program according to the present invention causes a computer to function as an obtaining unit for obtaining posted information from a poster; a conversion unit for converting the posted information such that the amount of information of the posted information is reduced, based on the level of the amount of information to be transmitted to a viewer, the level being determined depending on the relationship between the poster and the viewer; and a providing unit for providing the posted information converted to the viewer.

### Advantageous Effects of Invention

According to the present invention, it is possible to reduce the amount of information posted by a poster to an amount in accordance with the relationship between the poster and a viewer before providing to the viewer.

### BRIEF DESCRIPTION OF DRAWINGS

FIG. 1 is a system structure diagram of an information transmission system according to an embodiment of the present invention;

FIG. 2 shows a relationship between users;

FIG. 3 shows one example of a posted message;

FIG. 4 shows one example of a view message;

FIG. 5 shows one example of a view message;

FIG. 6 shows one example of a view message;

FIG. 7 is a functional block diagram of an information providing server;

FIG. 8 shows one example of conversion rule information;

FIG. 9 shows one example of message information stored;

FIG. 10 shows one example of a user information management table;

FIG. 11 shows one example of a message history information management table;

FIG. 12 is a flowchart of message storing processing in the first embodiment;

FIG. 13 is a flowchart of message providing processing in the first embodiment;

FIG. 14 is a flowchart of message providing processing in a second embodiment;

FIG. 15 shows one example of conversion rule information;

FIG. 16 shows one example of posted message;

FIG. 17 shows one example of a view message;

FIG. 18 shows one example of a view message; and

FIG. 19 shows one example of a view message.

### DESCRIPTION OF EMBODIMENTS

In the following, embodiments of the present invention (hereinafter referred to as an embodiment) will be described with reference to the accompanying drawings.

### [1. Description of System Structure]

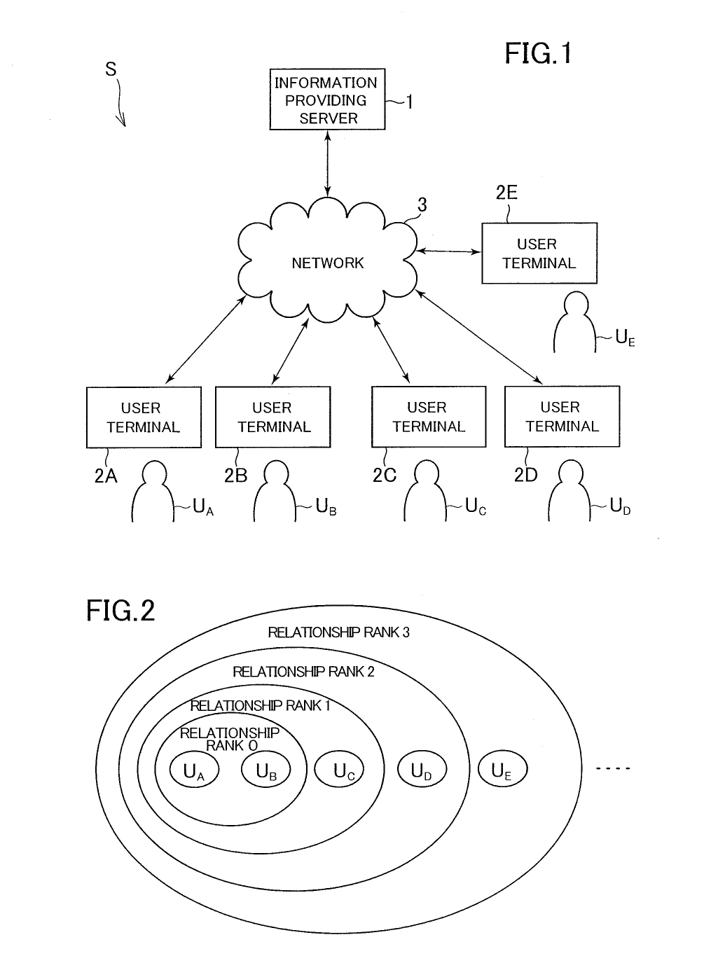

FIG. 1 is a system structure diagram of an information transmission system S according to an embodiment of the present invention. As shown in FIG. 1, the information transmission system S includes an information providing server 1 and one or more user terminals 2, in which the information providing server 1 mutually transmits data via a network 3, such as the Internet or the like. In this embodiment, assume that a user UA operates a user terminal 2A, a user UB operates a user terminal 2B, a user UC operates a user terminal 2C, a user UD operates a user terminal 2D, and a user UE operates a user terminal 2E. However, in referring to any one of these user terminals 2A to 2E, it is denoted as a user terminal 2.

In the information transmission system S according to this embodiment, the information providing server 1 receives a message from a user terminal 2 operated by a user who is a sender of the message, and sends the message received to a user terminal 2 operated by a user who is a viewer of the message. A message may include one or more addressees set thereto or no addressee. In the case of a message with an addressee set thereto, the information providing server 1 may provide the message to an addressee user set to the message. Meanwhile, in the case of a message without an addressee set thereto, the information providing server 1 may provide the message in response to an information view request sent from the user terminal 2. In the following, an outline of processing executed in the information transmission system S will be described, based on a specific example.

### [1-1. Description of Outline of Processing in Information Transmission System S]

In the example below, assume that a user A is a sender of a message, and users B, C, D, E are viewers of the message. Further assume that the relationship between the user A and the respective users B to E are as defined in FIG. 2. Specifically, the user A has a closer relationship with the respective users in the order of the user B (relationship rank 0)>the user C (relationship rank 1)>the user D (relationship rank 2)>and the user E (relationship rank 3). For example, the relationship rank indicates an extent of closeness in relationship with the user A, and a smaller rank indicates a closer relationship with the user A (that is, closer to the user A). The relationship rank may be set in advance by a user or set based on an evaluation result based on the number of times or frequencies at which messages are exchanged between users, the number of times at which messages are viewed, the number of friends commonly registered, or the like.

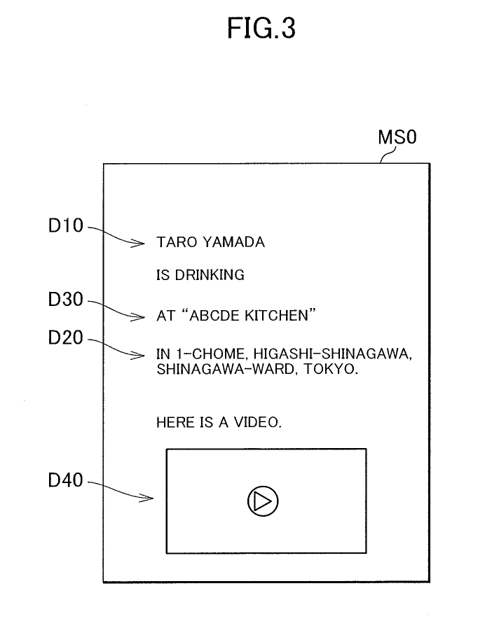

Based on an input by the user A, or the sender of a message, the user terminal 2A generates a posted message MS0, shown in FIG. 3, for example, and sends the posted message MS0 generated to the information providing server 1. As shown in FIG. 3, the posted message MS0 includes personal name data D10, address data D20, shop name data D30, and motion picture data D40.

The information providing server 1 sends the message posted from the user A to the user terminals 2B to E operated by the respective users B to E in response to requests from the respective user terminals 2B to E or according to the addressee set to the message. In the above, assume that the information providing server 1 converts messages to be sent to the respective users B to E, depending on the relationship ranks between the user A, or the sender of the message, and the users B to E or, viewers, such that the amount of information included in the message is smaller with respect to a viewer with a less close relationship with the sender, before sending. Note that the amount of information included in a message may be a scale indicating unlikelihood that an event indicated by the message will happen (for example, a larger unlikelihood that an event will happen (that is, a lower event happening probability) leads to a larger amount of information). For example, when a message is made unclear by partially deleting a word (a character string) included in the message or replacing a word included in the message by a word of a more superior concept, the number of events corresponding to the message made unclear increases, and therefore the amount of information of the message made unclear is reduced. As an example of conversion for reducing the amount of information (making information unclear) may include replacement of a first address by a second address of a region containing the first address or replacement of a personal name by information on attribute (for example, age or gender) possessed by the person.

For example, a user B having the relationship rank 0 with the user A may receive intact the message posted by the user A.

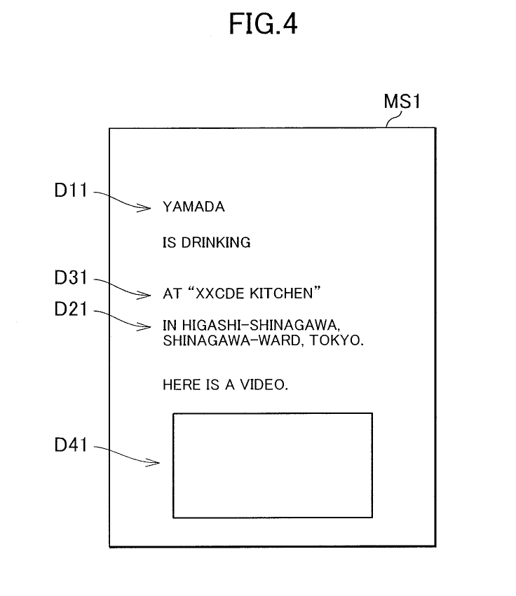

For the user C having the relationship rank 1 with the user A, as shown in FIG. 4, personal name data D10 in the message posted by the user A is converted into personal name data D11 (only a family name in the personal name data D10), address data D20 into address data D21 (the subordinate address segment to “Higashi-Shinagawa, Shinagawa-ward, Tokyo” in the address data D20 is deleted), shop name data D30 into shop name data D31 (two letters in the shop name data D30 are masked), and motion picture data D10 into motion picture data D11 (a static image of one frame in the motion picture data D10). As a result of the above, the user C will receive a message having an amount of viewable message information that is reduced to be smaller than that which will be received by the user B with the relationship rank 0.

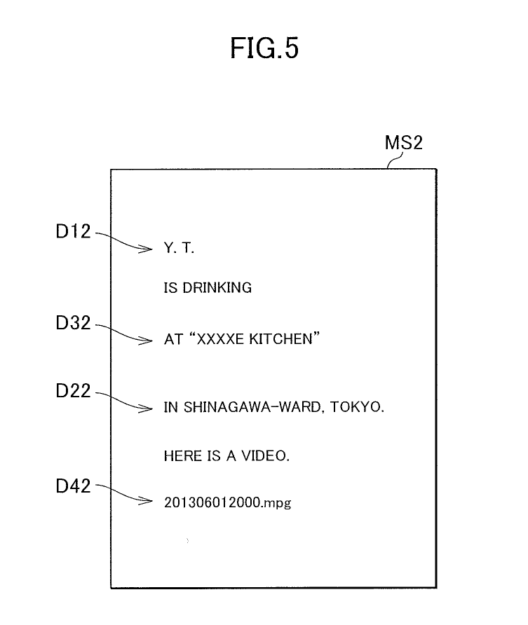

For the user D with the relationship rank 2 with the user A, as shown in FIG. 5, the personal name data D10 in the message posted by the user A is converted into personal name data D12 (only the initial in the personal name data D10), the address data D20 into address data D22 (the subordinate address segment to “Shinagawa-ward, Tokyo” in the address data D20 is deleted), the shop name data D30 into shop name data D32 (four letters in the shop name data D30 are masked), and the motion picture data D10 into motion picture data D11 (the file name of the motion picture data D10). As a result of the above, the user D will receive a message having an amount of viewable message information that is reduced to be smaller than that which will be received by the user C with the rank 1.

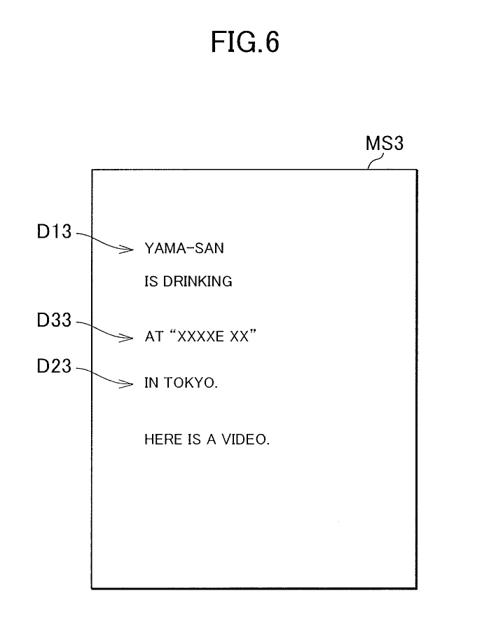

For the user E with the relationship rank 3 with the user A, as shown in FIG. 6, the personal name data D10 in the message posted by the user A is converted into personal name data D13 (a handle name corresponding to the personal name data D10), the address data D20 into address data D23 (the subordinate address segment to “Tokyo” in the address data D20 is deleted), and the shop name data D30 into shop name data D33 (six letters in the shop name data D30 are masked), and the motion picture data D10 is deleted. As a result of the above, the user E will receive a message having an amount of viewable message information that is reduced to be smaller than that which will be received by the user D with the rank 2.

As described above, according to the information transmission system S according to this embodiment, posted information from a sender of information is converted such that the amount of information thereof is smaller with respect to a viewer having a less close relationship with the sender, and the converted posted information is then provided to the respective viewers of the information.

### [2. Description on Functions of Information Providing Server 1]

In the following, one example of the functions of the information providing server 1 in order to implement the above described processing will be described.

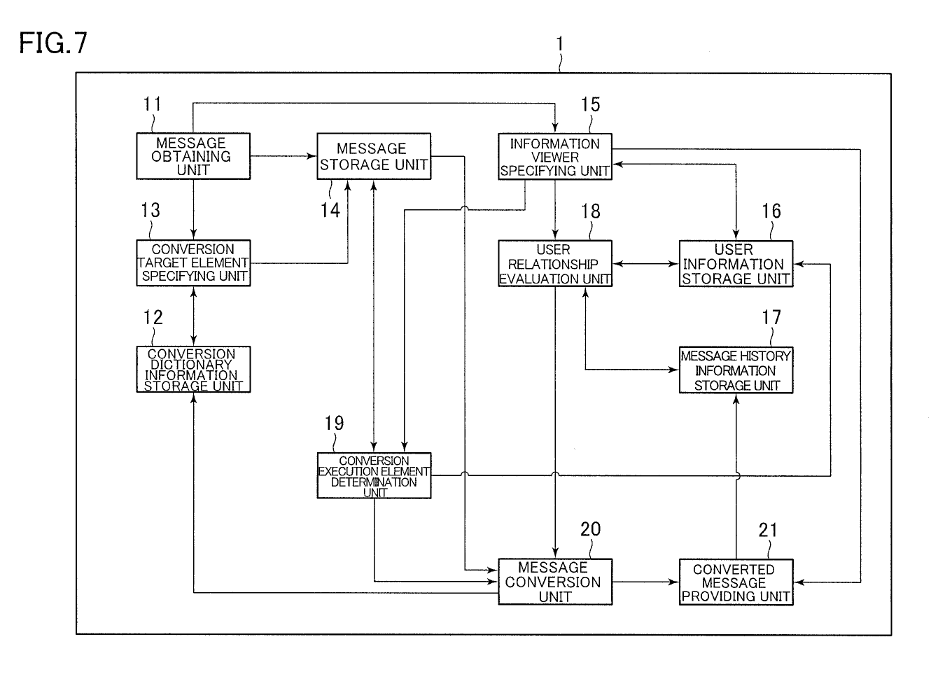

FIG. 7 is a functional block diagram of the information providing server 1. As shown in FIG. 7, the information providing server 1 includes a message obtaining unit 11, a conversion dictionary information storage unit 12, a conversion target element specifying unit 13, a message storage unit 14, an information viewer specifying unit 15, a user information storage unit 16, a message history information storage unit 17, a user relationship evaluation unit 18, a conversion execution element determination unit 19, a message conversion unit 20, and a converted message providing unit 21.

The functions of the respective units of the information providing server 1 may be implemented in a computer having a control means such as a CPU (Central Processing Unit) or the like, a storage means such as a semiconductor memory, a magnetic disk device, or the like, and a communication means, such as a network interface, or the like, by the control means by executing a program stored in the storage means. The program may be provided to the information providing server 1 in the form of being stored in an information storage medium or through a data transmission means such as the Internet or the like. In the following, details of the respective units of the information providing server 1 will be described.

The message obtaining unit 11 obtains message information (posted information) from the user terminal 2. The message information may include text data, image data (including a static image and a motion picture), sound data, or the like. The message information may or may not include an addressee (a mail address, addressee user identification information, or the like).

The conversion dictionary information storage unit 12 has stored therein specific dictionary information for specifying a data element to be a conversion target in the message information obtained from the message obtaining unit 11, and conversion rule information that defines a rule for converting the specified data element.

In this embodiment, for example, assume that according to the specific dictionary information, address information, contact information (a telephone number, a mail address, or the like), a specific proper noun (a personal name, a shop name, or the like), image data, or the like, are defined as conversion target data elements.

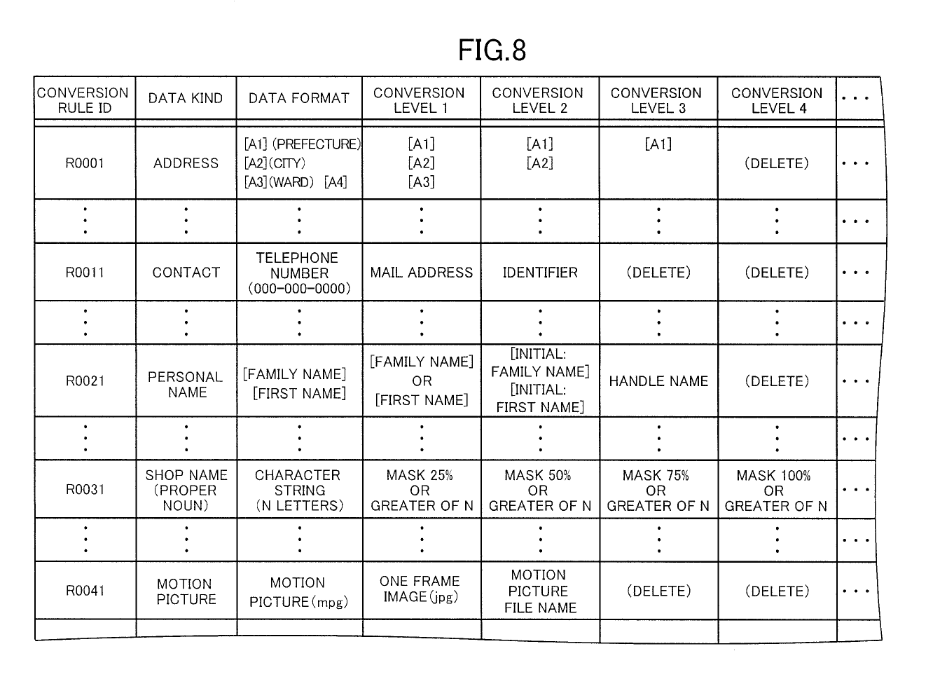

FIG. 8 shows one example of the conversion rule information. As shown in FIG. 8, the conversion rule information includes a conversion rule ID, the kind of a conversion target data element (an address, a contact, a personal name, a shop name, a motion picture), a data format of the conversion target information, and conversion rules for respective conversion levels so as to be correlated to one another. In the following, a specific example of the conversion rule will be described. Note that as the conversion level becomes higher (that is, in the order of the conversion levels 1 to N (N being an integer of two or greater), the amount of information of a data element becomes smaller (that is, the amount of information of a data element that is converted at the conversion level (i+1) is smaller than that which is converted at the conversion level i (i being an integer of one or greater)).

For example, in the case where the conversion target data element is address information, and the address information has a data structure including [A1] (prefecture), [A2] (city), [A3] (ward), and [A4], the conversion level 1 may involve [A1] (prefecture), [A2] (city), and [A3] (ward), the conversion level 2 may involve [A1] (prefecture) and [A2] (city), the conversion level 3 may involve [A1] (prefecture), and the conversion level 4 (or greater) may involve [delete].

For example, in the case where the conversion target data element is contact information, the contact information is expressed in a telephone number format and there are a mail address and an identifier (a user ID or the like) linked to the telephone number, the conversion level 1 may involve a corresponding mail address, the conversion level 2 may involve a corresponding identifier, and the conversion level 3 (or greater) may involve [delete].

For example, in the case where the conversion target data element is a personal name (name) and there is a handle name (nickname) linked to the personal name, the conversion level 1 may involve a family name or a first name, the conversion level 2 may involve an initial corresponding to the name, the conversion level 3 may involve a handle name, and the conversion level 4 (or greater) may involve [delete].

For example, in the case where the conversion target data element is a proper noun and no specific conversion rule is defined, the conversion level 1 may involve, in connection with the number of letters of the proper noun (N (N being an integer of one or greater)), [masking the number of letters corresponding to 25% or greater of N], the conversion level 2 may involve [masking the number of letters corresponding to 50% or greater of N], the conversion level 3 may involve [masking the number of letters corresponding to 75% or greater of N], and the conversion level 4 (or greater) may involve [delete].

For example, in the case where the conversion target data element is motion picture data, the conversion level 1 may involve [a static image of one frame extracted from the motion picture data], the conversion level 2 may involve [the file name of the motion picture data], and the conversion level 3 (or greater) may involve [delete].

The conversion target element specifying unit 13 specifies a data element to be a conversion target in the message information obtained by the message obtaining unit 11, based on the specific dictionary information stored in the conversion dictionary information storage unit 12. For example, as to each of the conversion target data elements specified in the message information, the conversion target element specifying unit 13 may store the kind of data, a conversion rule ID to be applied, or conversion candidate data for the respective conversion levels generated based on the conversion rule applied, so as to be correlated to one another.

The message storage unit 14 stores the message information obtained by the message obtaining unit 11 and information on the conversion target data element specified by the conversion target element specifying unit 13 with respect to that message information.

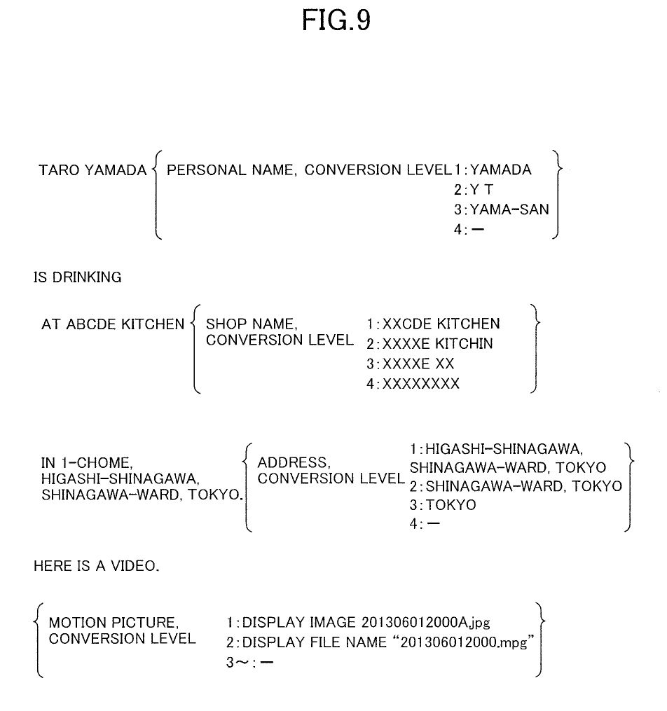

FIG. 9 shows one example of the message information stored in the message storage unit 14. In the example of the message information shown in FIG. 9, the kind of data and conversion candidate data for respective conversion levels are stored with respect to the data element specified by the conversion target element specifying unit 13 with respect to the message information, so as to be correlated to each other. In the following, the message information stored in the message storage unit 14 will be referred to as base message information.

The information viewer specifying unit 15 specifies a user (information viewer) who views information based on the message information stored in the message storage unit 14. For example, in the case where the message information includes an addressee or an addressee user to whom the message information will be notified is designated in advance with respect to a user who is the sender of the message information, the information viewer specifying unit 15 may specify the user ID of an information viewer, based on the addressee designated. Meanwhile, in the case where no addressee is designated with respect to the message information or the sender of the message information, the information viewer specifying unit 15 may specify the user ID of an information viewer, based on the data received from the user terminal 2 when viewing the message information is requested. Note that the information viewer specifying unit 15 may specify the user ID of an information viewer, based on the data received from the user terminal 2, when viewing the message information is requested also in the case where an addressee is designated with respect to the message information or the sender of the message information.

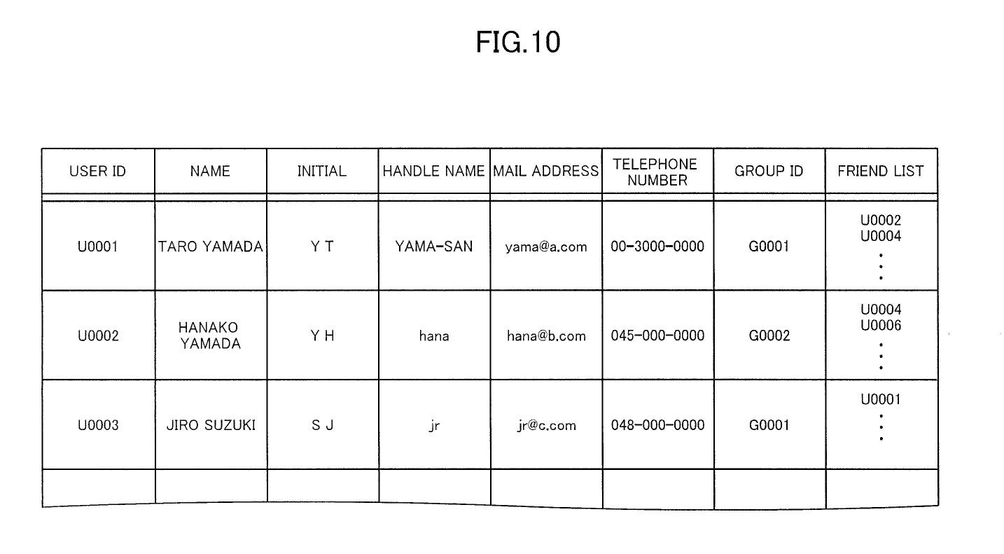

The user information storage unit 16 has user information stored therein. FIG. 10 shows one example of a user information management table stored in the user information storage unit 16. In the example of the user information management table shown in FIG. 10, a user ID for identifying a user, and the name, initial, handle name, mail address, telephone number, group ID, and a friend list of the user are stored so as to be correlated to one another.

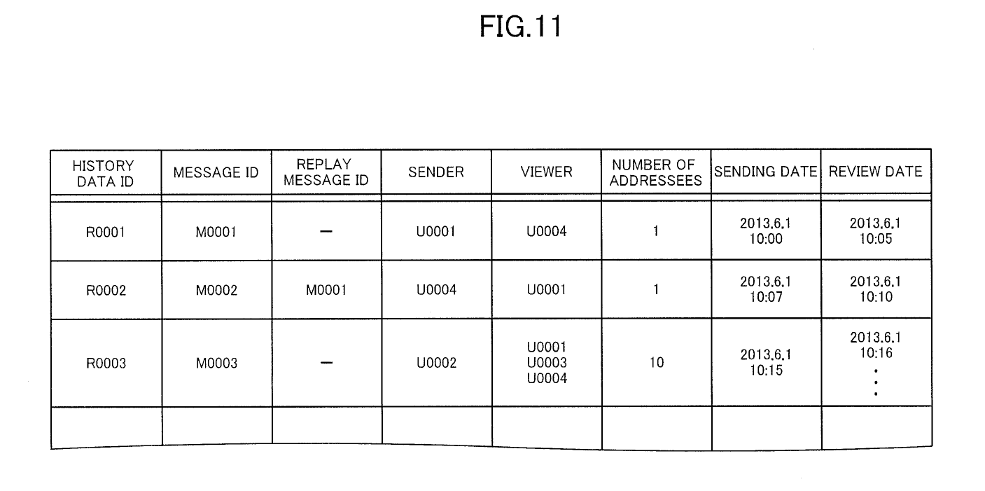

The message history information storage unit 17 has history information stored therein on information on a message sent and viewed by a user. FIG. 11 shows one example of the message history information management table stored in the message history information storage unit 17. In the example of the message history information management table shown in FIG. 11, a history data ID, a message ID, a reply message ID (an ID for identifying a message to which to reply if the message is a reply to a previous message), the sender of the message (a user ID), a viewer of the message (a user ID), the number of addressees of the message, the time and date at which the message is sent, the time and date at which the message is viewed are stored so as to be correlated to one another.

The user relationship evaluation unit 18 evaluates the relationship between the sender and a viewer of message information. In the following, a specific example of evaluation of the relationship between the sender and a viewer of message information will be described.

In a first evaluation example, the user relationship evaluation unit 18 may search the message history information management table for a message sent from the sender of target message information to a viewer of the same, calculate a first evaluation value, based on the number of messages found or a posting frequency of messages (the number of messages in a unit period) calculated based on the messages found, and determine a rank (a relationship rank) indicating the relationship between the sender and the viewer, based on in which range among a plurality of ranks the first evaluation value is included (for example, in the case of a0>a1>a2>a3, relationship rank 0: an evaluation value equal to or greater than a0, relationship rank 1: an evaluation value less than a0 and equal to or greater than a1, relationship rank 2: an evaluation value less than a1 and equal to or greater than a2, relationship rank 3: an evaluation value less than a2 and equal to or greater than a3, relationship rank 4: an evaluation value less than a3 or the like). Further, the user relationship evaluation unit 18 may set a weight to each of the messages found, and sum up the weights set to thereby calculate the first evaluation value. In this case, in the case where the number of addressee set to the message is one, for example, the weight may be set to one, and in the case where the number of addressee set to the message is N (N being an integer of one or greater), the weight may be set to 1/N. In the case where the number of addressees set to the message is unspecified, the weight may be set to a fixed value (for example, 0.1 or the like) or to 1/P, P being the average of the number of addressees set to the messages having been sent by the sender of the message in the past. Note that the messages counted in calculation of the average of the number of addressees may be all of the messages having been sent in the past or only those having been sent in a designated period.

In a second evaluation example, the user relationship evaluation unit 18 may search the message history information management table for a message (for example, the number of reply messages) having been exchanged between the sender and a viewer of the target message information, calculate a second evaluation value, based on the number of messages found or a exchange frequency of messages (the number of reply messages in a unit period) calculated based on the messages found, and determine a rank (a relationship rank) indicating the relationship between the sender and the viewer, based on in which range among a plurality of ranks the second evaluation value is included (for example, in the case of b0>b1>b2>b3, relationship rank 0: an evaluation value equal to or greater than b0, relationship rank 1: an evaluation value less than b0 and equal to or greater than b1, relationship rank 2: an evaluation value less than b1 and equal to or greater than b2, relationship rank 3: an evaluation value less than b2 and equal to or greater than b3, relationship rank 4: an evaluation value less than b3 or the like).

In a third evaluation example, the user relationship evaluation unit 18 may search the user information management table for a friend commonly included in a friend list linked to the sender of the target message information and in a friend list linked to a viewer of the same, calculate a third evaluation value, based on the number of friends found, and determine a rank (a relationship rank) indicating the relationship between the sender and the viewer, based on in which range among a plurality of ranks the third evaluation value is included (for example, in the case of c0>c1>c2>c3, relationship rank 0: an evaluation value equal to or greater than c0, relationship rank 1: an evaluation value less than c0 and equal to or greater than c1, relationship rank 2: an evaluation value less than c1 and equal to or greater than c2, relationship rank 3: an evaluation value less than c2 and equal to or greater than c3, relationship rank 4: an evaluation value less than c3 or the like). Further, the user relationship evaluation unit 18 may set a weight to each of the friends found, and sums up the weights set to thereby calculate the third evaluation value. In this case, a weight may be set to each of the friends found such that a higher weight is set to each of the friends of which number of exchanges (or exchange frequency) of messages with the sender of the target message information and that (or exchange frequency) with a viewer of the same are both high.

The conversion execution element determination unit 19 determines a data element (a conversion execution element) to which conversion is applied with respect to the viewer specified by the information viewer specifying unit 15 among the conversion target data elements included in the base message information. For example, the conversion execution element determination unit 19 may determine all of the conversion target data elements included in the base message information as conversion execution elements. Alternatively, the conversion execution element determination unit 10 may determine in advance a percentage in accordance with the relationship rank evaluated by the user relationship evaluation unit 18 with respect to the sender and a viewer of the base message information (for example, relationship rank 1: 0%, relationship rank 2: 25%, relationship rank 3: 50%, relationship rank 4: 75%, relationship rank 5: 100% or the like), and select a conversion execution element from among the conversion target data elements included in the base message information, based on the percentage determined. In selection of a conversion execution element from among the conversion target data elements included in the base message information, the conversion execution element determination unit 19 may select, beginning with one with a higher priority level determined with respect thereto. For example, the priority level of a conversion target data element may be determined for every kind of data (for example, the order of priority is determined as personal name>address>contact>motion picture>shop name or the like) or depending on the amount of data included in the conversion target data element (for example, the priority order is the order of data elements having a larger number of bytes). The priority level to be determined for every kind of data element may be set in advance by a user who is the sender of a message. The conversion execution element determination unit 19 may exclude information (hereinafter referred to as common friend information) on a user identical to a user included in both of the friend list of the sender of the base message information and that of a viewer of the same among the conversion target data elements included in the base message information. For example, in the case where the relationship rank between the sender and a viewer of the base message information is equal to or greater than a threshold (or greater than a threshold), the conversion execution element determination unit 19 may lower the priority level of a data element corresponding to common friend information in selection of a conversion execution element to below the priority level set in advance to that data element (or a priority level of other data element). Meanwhile, in the case where the relationship rank between the sender and a viewer of base message information is equal to or less than a threshold (or less than a threshold), the conversion execution element determination unit 19 may increase the priority level of a data element corresponding to common friend information in selection of a conversion execution element to be higher than the priority level set in advance to that data element (or a priority level of other data element).

The message conversion unit 20 converts the respective data elements (conversion execution elements) determined by the conversion execution element determination unit 19 with respect to the base message information to be provided to the viewer specified by the information viewer specifying unit 15, at a conversion level in accordance with the evaluation result (rank) evaluated by the user relationship evaluation unit 18 with respect to that viewer, to thereby generate converted message information.

For example, the message conversion unit 20 may convert the data element in the base message information, determined by the conversion execution element determination unit 19 into data at a conversion level corresponding to the rank obtained by the user relationship evaluation unit 18 (for example, the rank i may correspond to the conversion level i). Specifically, the message conversion unit 20 may replace the data element in the base message information, determined by the conversion execution element determination unit 19 by the content of a conversion candidate for the conversion level corresponding to the rank obtained by the user relationship evaluation unit 18, the conversion candidate for the conversion level being selected from among the conversion candidates for the respective conversion levels determined with respect to that data element.

The converted message providing unit 21 provides the converted message information subjected to conversion by the message conversion unit 20 to the viewer specified by the information viewer specifying unit 15. For example, the converted message providing unit 21 may send the converted message information generated with respect to a viewer to the user terminal 2 operated by the viewer, or a notice addressee, such as a mail address or the like, linked to the viewer.

### [3. Description on Flow]

In the following, details of the processing executed by the information providing server 1 will be described referring to a flowchart.

### 3-1. First Embodiment

Initially, as a first embodiment, a case in which a posted message does not include an addressee, a message posted from the user terminal 2 is stored, and the stored message is provided in response to a request from another user terminal 2 will be described as an example.

### [3-1(1). Posted Message Storing Processing]

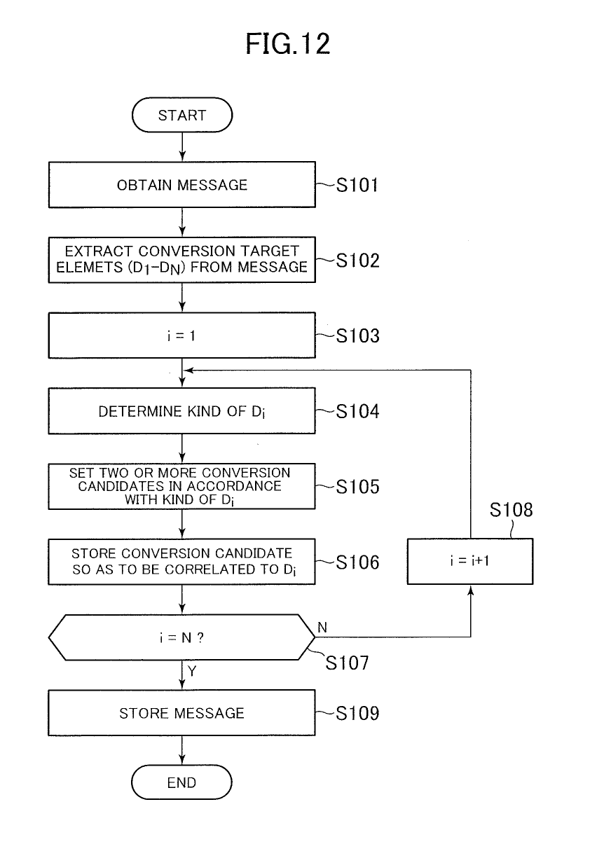

FIG. 12 shows a flowchart of message storing processing in the first embodiment.

As shown in FIG. 12, the information providing server 1 obtains message information from the user terminal 2 operated by a poster of a message (S101), and extracts a data element to be a conversion target (conversion target elements D1 to DN) from the message information obtained (S102). A conversion target element may be information expressed in a predetermined format, information included in predetermined dictionary, or the like. Note here that “N” in “DN” refers to the number of data elements extracted from the message information, being an integer of one or greater.

The information providing server 1 initializes the variable i to 1 (S103), determines the kind of data (for example, any of address information, contact information (telephone number, mail address, or the like), personal name, shop name, and image data) of the conversion target element Di, based on the dictionary information (S104), specifies a conversion rule in accordance with the kind of data of the conversion target element Di, based on the dictionary information, and sets conversion candidates for a plurality of respective conversion levels with respect to the conversion target element Di, based on the conversion rule specified (S105). Note here that, when conversion levels 1 to L (L being an integer of two or greater) are assumed, conversion candidates corresponding to the respective conversion levels 1 to L are generated such that the amount of information becomes smaller as the conversion level becomes higher. The information providing server 1 stores the conversion target element Di and the conversion candidates for the plurality of respective conversion levels set with respect to the conversion target element Di so as to be correlated to each other (S106).

In the case where the variable i does not reach N (S107: N), the information providing server 1 increments the variable i (add one) (S108) before returning to S104, and executes subsequent processing again.

Meanwhile, in the case where the variable i reaches N (S107: Y), the information providing server 1 stores the message information (S109 and ends the storing processing. Note that at S109 the message information may be stored so as to be correlated to the user ID of the sender of the message information (for example, in the message history information management table).

### [3-1(2). Message Providing Processing]

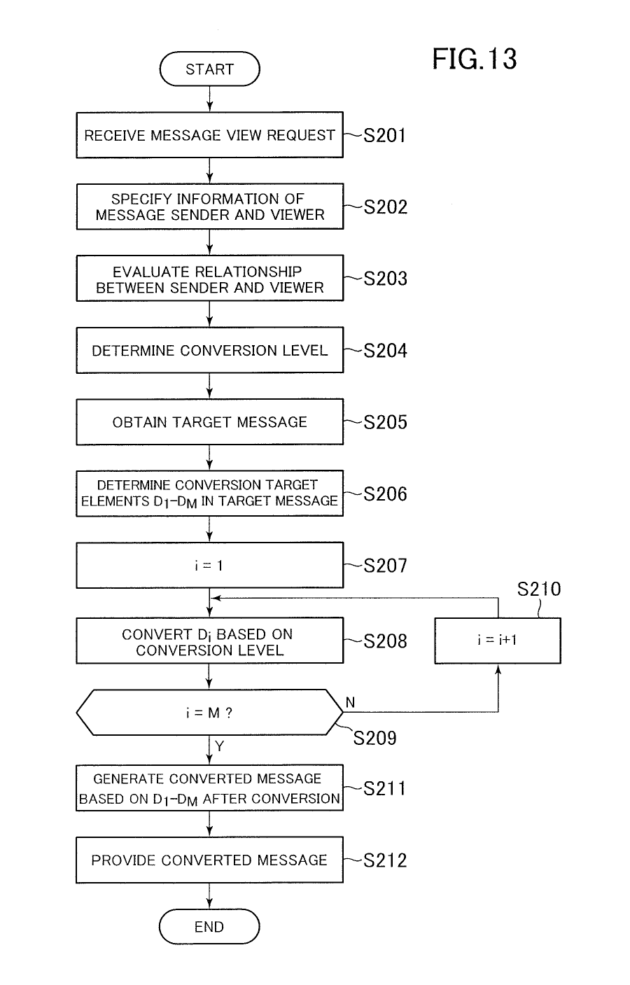

In the following, with reference to FIG. 13, details of the processing (message providing processing) that is executed in the first embodiment upon receipt of a request for viewing message information stored from the user terminal 2, the processing for converting the message information relevant to the view request, based on the relationship between the sender and the viewer of the message information, and providing to the user terminal 2 relevant to the view request will be described.

As shown in FIG. 13, when the information providing server 1 receives a request for viewing message information (for example, a message ID relevant to a request or the user ID of a requester) from the user terminal 2 (S201), the information providing server 1 specifies information on the sender of the message information relevant to the view request and information on the viewer of the message information (the user IDs of the sender and the viewer) (S202).

Thereafter, the information providing server 1 causes the user relationship evaluation unit 18 to evaluate the relationship (rank) between the sender and the viewer (S203), and determines a conversion level for the message information, based on the obtained relationship (rank) (S204). For example, in the case where the relationship rank between the sender and the viewer is R (R being an integer equal to or greater than 0), the information providing server 1 may determine the conversion level L for the message information as L=R. In the case of the conversion level 0, conversion may not be executed.

The information providing server 1 searches the message storage unit 14 to obtain the message information relevant to the view request, using the message ID received as a key (S205), and causes the conversion execution element determination unit 19 to determine data elements D1 to DM to be converted among the conversion target data elements included in the message information obtained (S206). Note that “M” in “DM” refers to the number of data elements to be converted, being an integer of one or greater.

The information providing server 1 initializes the variable i to 1 (S207), and converts the data element Di determined as a conversion execution element, based on the conversion level L determined at S204 (S208). For example, the information providing server 1 may convert the data element Di, using a conversion candidate corresponding to the conversion level L among those for the respective conversion levels with respect to the data element Di.

In the case where the variable i does not reach M (S209: N), the information providing server 1 may increment the variable i (add one) (S210) before returning to S208, and executes subsequent processing again.

Meanwhile, in the case where the variable i reaches M (S209: Y), the information providing server 1 generates converted message information by converting the original message information (base message information) based on the data elements D1 to DM after conversion (S211), and provides the generated converted message information to the user terminal 2 relevant to the view request (S212).

The above describes a flow of message providing processing according to the first embodiment. According to the processing in the first embodiment, even in a case where a user who views a message is unspecified at the time of posting the message, a message in the amount of information that is reduced depending on the relationship with the sender of the message and a viewer of the message is provided to the viewer.

### 3-2. Second Embodiment

In the following, as a second embodiment, a case will be described in which a message posted by a user includes one or more addressees, and the posted message is converted before being provided to each of the addressee users set to the message.

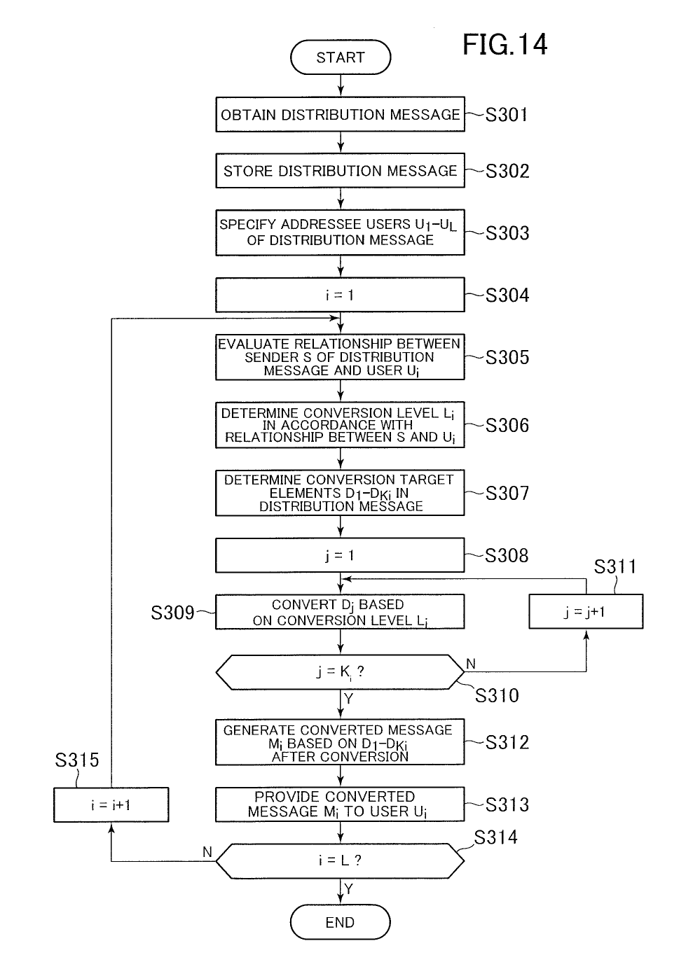

FIG. 14 shows a flowchart of message providing processing according to the second embodiment.

As shown in FIG. 14, the information providing server 1 obtains message information (distribution message) including an addressee set thereto from the user terminal 2 (S301), and stores the message information obtained (S302). Note that the message information storing processing is not described here as processing similar to that shown in the flowchart (FIG. 12) referred to in description of the message storing processing in the first embodiment can be applied.

The information providing server 1 specifies users U1 to UL who are addressees of the message information obtained at S301 (S303). For example, an addressee may be designated in the message information or set so as to be correlated to a user who is the sender of the message information. Note here that “L” in “UL” refers to the number of users who are addressees of the message information, being an integer of one or greater.

The Information providing server 1 initializes the variable i to 1 (S304), causes the user relationship evaluation unit 18 to evaluate the relationship between the sender S of the message information and an addressee user Ui (S305), and determines a conversion level Li in accordance with the relationship between the sender S and the user Ui (S306). For example, in the case where the relationship rank between the sender S and the user Ui is R (R being an integer equal to or greater than 0), the information providing server 1 may determine the conversion level Li of the message information as Li=R. Note that in the case where the conversion level is 0, conversion may not be executed.

The information providing server 1 causes the conversion execution element determination unit 19 to determine data elements D1 to DKi to be converted among the conversion target data elements included in the message information (S307). Note that Ki is an integer of one or greater.

The information providing server 1 initializes the variable j to 1 (S308), and converts the data element Dj, based on the conversion level Li determined at S306 (S309). For example, the information providing server 1 may convert the content of data of the data element Dj, using a conversion candidate corresponding to the conversion level Li among the conversion candidates for the respective conversion levels with respect to the data element Dj.

In the case where the variable j does not reach Ki (S310: N), the information providing server 1 increments the variable j (add one) (S311) before returning to S309, and executes subsequent processing again.

Meanwhile, in the case where the variable j reaches Ki (S310: Y), the information providing server 1 generates converted message information Mi by converting the original message information (base message information), based on the data elements D1 to DKi after conversion (S312), and provides the generated converted message information Mi to the user Ui (S313). For example, the information providing server 1 may send the converted message information Mi to the addressee information (mail address) of the user Ui or to the user terminal 2 operated by the user Ui. Note here that the information providing server 1 may update the history information in the message history information management table, based on the message information sent.

In the case where the variable i does not reach L (S314: N), the information providing server 1 increments the variable i (add one) (S315) before returning to S305, and executes subsequent processing again. Meanwhile, in the case where the variable i reaches L at S314 (S314: Y), the information providing server 1 ends the processing.

The above describes the message providing processing according to the second embodiment. According to the processing in the second embodiment, in the case as well in which a message is distributed to a designated user, a message in the amount of information that is reduced depending on the relationship with the sender of the message and the viewer of the message is provided to the viewer.

### [4. Description on Example of Data Conversion]

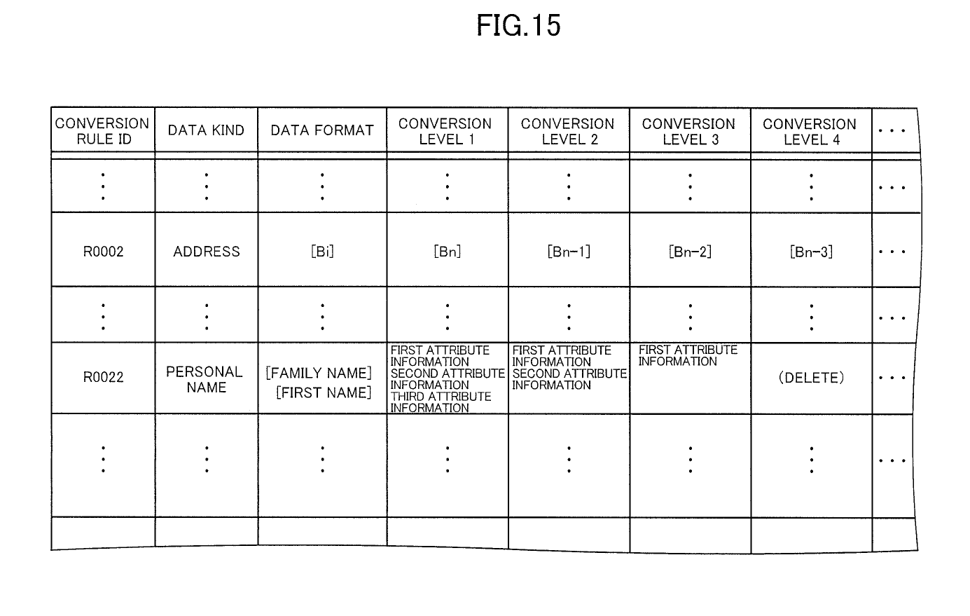

In the following, another example of an aspect of conversion of data included in the message information will be described with reference to FIGS. 15 to 19.

FIG. 15 shows one example of the conversion rule information. In the example shown in FIG. 15, an example of the conversion rule information with the kind of data being an address and a personal name will be described.

As shown in FIG. 15, in the case where the conversion target data is an address (for example, B0 (country), B1 (prefecture), B2 (city), B3 (ward), B4 or the like) and the conversion target data format is [Bn], at the conversion level 1, [Bn] may be converted into [Bn−1], which is a superior address segment. At the conversion level 2, [Bn] may be converted into [Bn−2], or a further superior address segment. At the conversion level 3, [Bn] may be converted into [Bn−3], or a yet further superior address segment. At the conversion level 4, [Bn] may be converted into [Bn−4], or the still yet further superior address segment. In the case where n−i in [Bn−i] is less than 0, [Bn−i] may be replaced by B0. As described above, the address data may be replaced by an address of a larger region that contains the original address as the conversion level becomes larger. Application of the above described manner of conversion is not limited to the case in which the conversion target data is an address. That is, conversion target data may be replaced by a term of more superior concept as the conversional level becomes larger.

As shown in FIG. 15, in the case where the conversion target data is a personal name, the conversion target data (a conversion target user name) may be converted by converting, at the conversion level 1, the conversion target user name into first to N^{th} (N being an integer of one or greater) attribute information items on the conversion target user, at the conversion level 2, into the first to the (N−1)^{th} attribute information items on the conversion target user, or at the conversion level 3, into the first to the (N−2)^{th} attribute information items on the conversion target user. In the case where N−i is equal to or less than 0, the conversion target user name may be deleted. For example, FIG. 15 shows an example with N being 3, in which the first attribute information may be the gender of a user, the second attribute information may be the age of the user, and the third attribute information may be the relationship between the sender of a message and a conversion target user, or the like. Note that the gender and age of a user and a relationship between the sender of a message and a conversion target user may be obtained by referring to the content of a database that manages user information. As described above, the personal name data may be converted into one or more attribute information items so that a smaller number of attribute information items are displayed as the conversion level becomes larger.

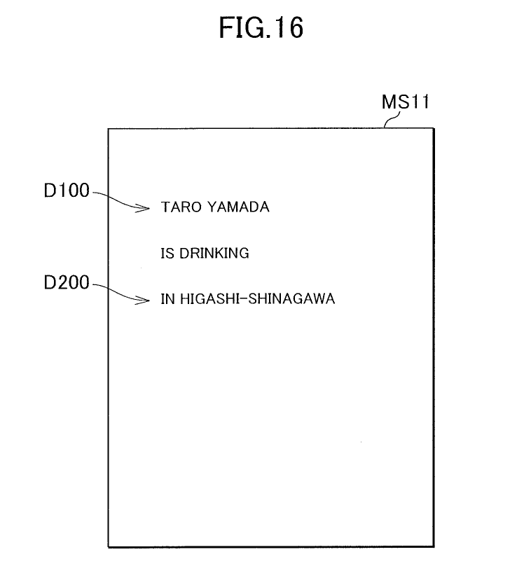

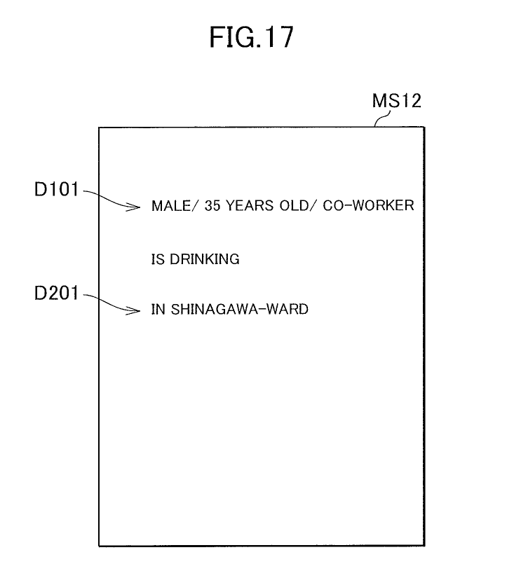

FIG. 16 shows one example of a message to be posted. FIGS. 17 to 19 each show one example of a converted message subjected to conversion for every viewer, based on the conversion rule information described with reference to FIG. 15. Assume here that the user A is the sender of a message, and the users B, C, D, E are viewers of the message. Further, assume that the relationship between the user A and the respective users B to E is as defined in FIG. 2.

FIG. 16 shows one example of the posted message MS01 posted from the user A. As shown in FIG. 16, the posted message MS11 includes personal name data D100 and address data D200. The posted message MS01 is sent to the information providing server 1 by the user terminal 2A.

The information providing server 1 converts the message posted by the user A, when necessary, depending on the respective relationship ranks between the user A, or the sender of the message, and the respective users B to E, or viewers, before providing to the respective users.

For example, the user B belonging to the relationship rank 0 with the user A may receive intact the message posted by the user A.

The user C having the relationship rank 1 with the user A receives a message M12 obtained by converting the personal name data D100 in the message posted by the user A into personal name data D101 (first attribute information (gender), second attribute information (age), and third attribute information (relationship with the sender) linked to the personal name data D100), and the address data D200 into the address data D201 (a superior address segment to the address data D200), as shown in FIG. 17.

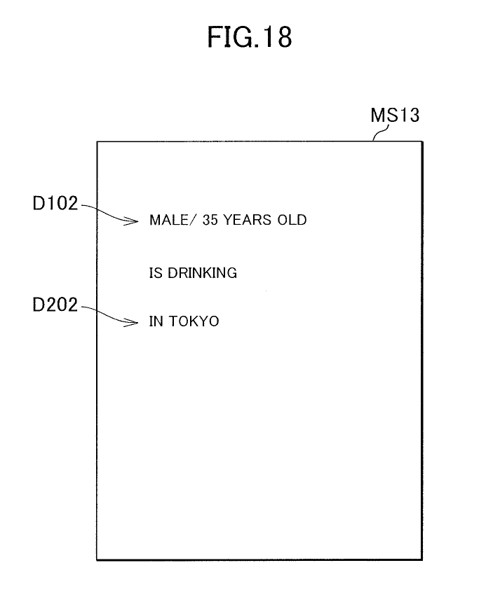

The user D with the relationship rank 2 with the user A receives a message M13 obtained by converting the personal name data D100 in the message posted by the user A into the personal name data D102 (first attribute information (gender) and second attribute information (age) linked to the personal name data D100), and the address data D200 into the address data D202 (a superior address segment to D201), as shown in FIG. 18.

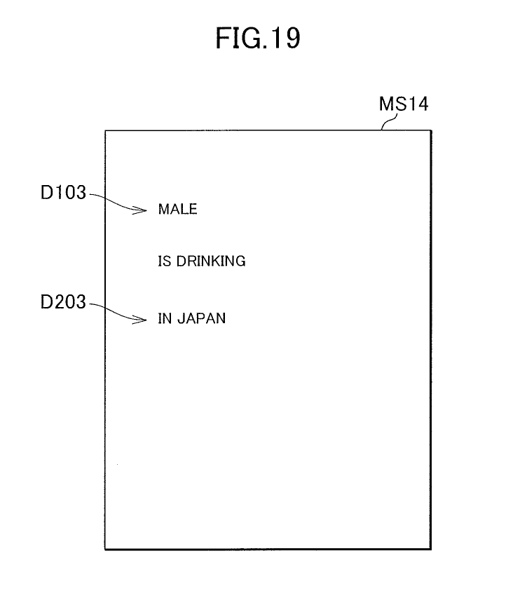

The user E with the relationship rank 3 with the user A receives a message M14 obtained by converting the personal name data D100 in the message posted by the user A into the personal name data D103 (first attribute information (gender) linked to the personal name data D100), and the address data D200 into the address data D203 (a superior address segment to D202), as shown in FIG. 19.

The present invention is not limited to the above described embodiments. For example, the information providing server 1 may determine the number of data elements to be converted among the conversion target data elements included in the message information, depending on the relationship rank between the sender and a viewer of the message information (for example, determined such that the number of data elements to be converted becomes larger as the relationship between the sender and a viewer becomes less close). In this case, the kind of a data element to be converted may be determined, depending on the relationship rank (for example, determined such that the number of kinds of data elements to be converted becomes larger as the relationship between the sender and a viewer becomes less close).

1. An information providing device, comprising:
at least one memory configured to store computer program code;
at least one processor configured to access said memory and operate as instructed by said computer program code, said computer program code including:
obtaining code configured to cause at least one of said at least one processor to obtain posted information from a poster;
conversion code configured to cause at least one of said at least one processor to convert the posted information such that an amount of information of the posted information is reduced, based on a level of an amount of information to be transmitted to a viewer, the level being determined depending on a relationship between the poster and the viewer; and
providing code configured to cause at least one of said at least one processor to provide the posted information converted to the viewer.

2. The information providing device according to claim 1, further comprising extracting code configured to cause at least one of said at least one processor to extract one or more data elements to be a conversion target from the posted information, wherein the conversion code causes at least one of said at least one processor to reduce an amount of information of each of the data elements extracted, based on the level of the amount of information determined depending on the relationship between the poster and the viewer.

3. The information providing device according to claim 2, further comprising a storage that stores conversion rule information that defines a conversion rule for conversion into a plurality of conversion candidates that are different in the level of the amount of information for every kind of data, wherein the conversion code causes at least one of said at least one processor to convert each of the data elements extracted, based on conversion rule information stored in the storage with respect to a kind of that data element and the level of the amount of information determined depending on the relationship between the poster and the viewer.

4. The information providing device according to claim 1, further comprising evaluation value obtaining code configured to cause at least one of said at least one processor to obtain an evaluation value indicating closeness in relationship between the poster and each of one or more viewers, wherein the conversion code causes at least one of said at least one processor to convert such that an amount of information of the posted information converted with respect to a first viewer is smaller than an amount of information of the posted information converted with respect to a second viewer when it is determined, based on the evaluation value obtained, that a relationship between the poster and the first viewer is less close than a relationship between the poster and the second viewer.

5. The information providing device according to claim 4, wherein the conversion code causes at least one of said at least one processor to convert such that an amount of information of a data element obtained by converting a data element extracted to be a conversion target from the posted information with respect to the first viewer is smaller than an amount of information of a data element obtained by converting a data element as the conversion target with respect to the second viewer when it is determined, based on the evaluation value obtained, that the relationship between the poster and the first viewer is less close than the relationship between the poster and the second viewer.

6. The information providing device according to claim 4, wherein the conversion code causes at least one of said at least one processor to extract a larger number of data elements to be a conversion target from the posted information with respect to the first viewer than a number of data elements extracted to be the conversion target from the posted information with respect to the second viewer when it is determined, based on the evaluation value obtained, that the relationship between the poster and the first viewer is less close than the relationship between the poster and the second viewer.

7. The information providing device according to claim 2, wherein when the data element extracted is a proper noun, the conversion code causes at least one of said at least one processor to mask or delete a number of letters in a character string included in the data element, the number being determined based on the level of the amount of information determined depending on the relationship between the poster and the viewer, to thereby convert the data element.

8. The information providing device according to claim 2, wherein when the data element extracted by the extracting means is address data, the conversion code causes at least one of said at least one processor to delete an address composing segment determined based on the level of the amount of information determined depending on the relationship between the poster and the viewer in an address composing segment included in the data element or replace the address composing segment included in the data element by a superior address composing segment corresponding to the level of the amount of information determined depending on the relationship between the poster and the viewer, to thereby convert the data element.

9. The information providing device according to claim 2, wherein when replacement data for replacement depending on the level of the amount of information is defined with respect to the data element extracted, the conversion code causes at least one of said at least one processor to replace the data element by replacement data corresponding to the level of the amount of information determined depending on the relationship between the poster and the viewer.

10. The information providing device according to claim 2, wherein when the data element extracted is a motion picture data, the conversion code causes at least one of said at least one processor to convert the motion picture data into a static image included in the motion picture data or attribute information of the motion picture data, depending on the level of the amount of information determined depending on the relationship between the poster and the viewer.

11. The information providing device according to claim 2, wherein the extracting code causes at least one of said at least one processor to extract one or more data elements to be a conversion target from among the data elements included in the posted information, depending on priority levels set to respective data elements included in the posted information.

12. The information providing device according to claim 11, further comprising:
evaluation value obtaining code configured to cause at least one of said at least one processor to obtain an evaluation value indicating closeness in relationship between the poster and the viewer; and
setting code configured to cause at least one of said at least one processor to set a lower priority level to data on a user commonly included in a list of users linked to the poster and a list of users linked to the viewer in selection of a conversion target than a predetermined priority level when the evaluation value obtained with respect to the poster and the viewer is equal to or greater than a threshold or greater than the threshold.

13. The information providing device according to claim 11, further comprising:
evaluation value obtaining code configured to cause at least one of said at least one processor to obtain an evaluation value indicating closeness in relationship between the poster and the viewer; and
setting code configured to cause at least one of said at least one processor to set a higher priority level to data on a user commonly included in a list of users linked to the poster and a list of users linked to the viewer in selection of a conversion target than a predetermined priority level when the evaluation value obtained with respect to the poster and the viewer is equal to or greater than a threshold or greater than the threshold.

14. An information providing method performed by at least one computer processor, comprising:
obtaining posted information from a poster;
converting the posted information such that an amount of information of the posted information is reduced, based on a level of an amount of information to be transmitted to a viewer, the level being determined depending on a relationship between the poster and the viewer; and
providing the posted information converted to the viewer.

15. (canceled)

16. The information providing device according to claim 3,
wherein when the data element extracted is a proper noun, the conversion code causes at least one of said at least one processor to mask or delete a number of letters in a character string included in the data element, the number being determined based on the level of the amount of information determined depending on the relationship between the poster and the viewer, to thereby convert the data element.

17. The information providing device according to claim 3,
wherein when the data element extracted is address data, the conversion code causes at least one of said at least one processor to delete an address composing segment determined based on the level of the amount of information determined depending on the relationship between the poster and the viewer in an address composing segment included in the data element or replace the address composing segment included in the data element by a superior address composing segment corresponding to the level of the amount of information determined depending on the relationship between the poster and the viewer, to thereby convert the data.

18. The information providing device according to claim 3,
wherein when replacement data for replacement depending on the level of the amount of information is defined with respect to the data element extracted, the conversion code causes at least one of said at least one processor to replace the data element by replacement data corresponding to the level of the amount of information determined depending on the relationship between the poster and the viewer.

19. The information providing device according to claim 3,
wherein when the data element extracted is a motion picture data, the conversion code causes at least one of said at least one processor to convert the motion picture data into a static image included in the motion picture data or attribute information of the motion picture data, depending on the level of the amount of information determined depending on the relationship between the poster and the viewer.

20. The information providing device according to claim 3,
wherein the extracting code causes at least one of said at least one processor to extract one or more data elements to be a conversion target from among the data elements included in the posted information, depending on priority levels set to respective data elements included in the posted information.
